(19) United States
(12) Patent Application Publication
(10) Pub. No.: US 2022/0121387 A1
(43) Pub. Date: Apr. 21, 2022

(54) METHOD FOR ESTIMATING READ REFERENCE VOLTAGES FOR FLASH STORAGE USING NEURAL NETWORK AND APPARATUS THEREFOR

(71) Applicant: Korea Advanced Institute of Science and Technology, Daejeon (KR)

(72) Inventors: Jeongseok Ha, Daejeon (KR); Seokju Han, Daejeon (KR); Jieun Oh, Daejeon (KR)

(73) Assignee: Korea Advanced Institute of Science and Technology, Daejeon (KR)

(21) Appl. No.: 17/076,274

(22) Filed: Oct. 21, 2020

(51) Int. Cl. G06F 3/06

(52) U.S. Cl. CPC G06F 3/0653; G06F 3/0616; G06F 3/0679

(57) ABSTRACT

Disclosed is a method for estimating a read reference voltage for a flash memory using a neural network and an apparatus therefor. According to an embodiment of the inventive concept, a method for reading a flash memory may include receiving predetermined variable values with respect to a flash memory, estimating a read reference voltage corresponding to the received variable values, using a neural network of a pre-trained learning model with respect to the variable values, and reading the flash memory, using the estimated read reference voltage. The method may further include updating the learning model of the neural network by reflecting a difference in characteristics between individual chips constituting the flash memory.

### BACKGROUND

Embodiments of the inventive concept described herein relate to a flash memory reading technology, and more particularly, relate to a flash memory reading method that estimates read reference voltages changed depending on system variables of a flash memory, for example, a NAND flash memory, using the neural network of a pre-trained learning model, and performs the read operation of the flash memory based on the estimated read reference voltage, and an apparatus therefor.

In NAND flash memories, the distribution of threshold voltages continuously is changed depending on variables such as data retention time, program/erase cycles, and the like. The technology (U.S. Pat. No. 8,923,066 B1) according to the conventional embodiment refers to a technology for adaptively estimating the optimal read reference voltage depending on the change of such the threshold voltage, and refers to a technology that applies various physical noises to a chip at the design time of SSD to intentionally change a threshold voltage, and then measures the optimal read reference voltage from the changed threshold voltage distribution to perform linear approximation on the relationship between the optimal read reference voltage and system variables, using a linear function. That is, the conventional technology may model the optimal read reference voltage as a linear combination of variables that cause the change in threshold voltages. The variables of the approximated linear function are measured for each block, and the measured values are stored in a separate memory of SSD in the form of a look-up table. Here, when the distribution of the threshold voltage is given, the optimal read reference voltage is a point where adjacent states intersect with one another.

The default reference voltage used by a NAND flash memory controller to read data is determined at the manufacturing stage. However, such the default read reference voltage is not optimal for the distribution of the threshold voltage changed as the number of read/write cycles of storage media and the usage time are increased. Accordingly, the memory life is shortened and the complexity of the error correction decoder increases due to the high bit error rate. The above-described conventional technology performs linear approximation on the optimal read reference voltage in the form of a linear combination of factors that cause the change in threshold voltages to adaptively adopt the optimal read reference voltage to the change in the threshold voltage distribution. However, the above-described conventional technology has several limitations. (1) An error occurs when the optimal read reference voltage is approximated through a linear combination of system variables. (2) The change of the optimal reference voltage according to the system variables is different for respective flash memory-based storage medium. There may be an error between mathematical modeling and actually-changed distribution. For example, the wear out of a device according to the data storage time is implemented through Arrehnious model by generally approximating the relationship between the wear out and the temperature. There is an error of the actually-changed distribution in the wear out. (3) The optimal read reference voltage measured at the manufacturing stage fails to be adaptively updated for a user's environment. For example, the distribution of the threshold voltage is randomly changed depending on usage habits and the type of data frequently employed by users.

### SUMMARY

Embodiments of the inventive concept provide a flash memory read method that estimates a read reference voltage changed depending on system variables of a flash memory, for example, NAND flash memory, using the neural network of a pre-trained learning model, and performs the read operation of the flash memory based on the estimated read reference voltage, and an apparatus therefor.

According to an exemplary embodiment, a flash memory reading method includes receiving predetermined variable values with respect to a flash memory, estimating a read reference voltage corresponding to the received variable values, using a neural network of a pre-trained learning model with respect to the variable values, and reading the flash memory, using the estimated read reference voltage.

The variable values include at least one or more of a programming/erase cycle count, retention time, and a location variable within a block.

Furthermore, the flash memory reading method according to an embodiment of the inventive concept further includes updating the learning model of the neural network by reflecting a difference in characteristics between individual chips constituting the flash memory.

The updating of the learning model includes obtaining labeled sample data for the respective individual chip, using a voltage optimization scheme, and updating the learning model of the neural network, using the labeled sample data.

The neural network minimizes a predefined loss function through training using a training data set including the predetermined variable values and read reference voltages for each of the predetermined variable values, and the learning models is generated.

The neural network is optimized through a supervised learning and the learning model is generated.

The location variable within the block includes a location variable of a page within the block, a type variable of the page, and a type variable of a bit line.

According to an exemplary embodiment, a memory reading method includes receiving predetermined variable values with respect to a memory, estimating a read reference voltage corresponding to the received variable values, using a neural network of a pre-trained learning model with respect to the variable values, and reading the memory, using the estimated read reference voltage.

The variable values include at least one or more of a programming/erase cycle count, retention time, and a location variable within a block, when the memory is a flash memory.

Furthermore, a memory reading method according to an embodiment of the inventive concept includes updating the learning model of the neural network by reflecting differences in characteristics between individual chips constituting the memory.

The updating of the learning model includes obtaining labeled sample data for the respective individual chip, using a voltage optimization scheme, and updating the learning model of the neural network, using the labeled sample data.

According to an exemplary embodiment, a flash memory reading apparatus includes a receiving unit for receiving predetermined variable values with respect to a flash memory, an estimating unit for estimating a read reference voltage corresponding to the received variable values, using a neural network of a pre-trained learning model with respect to the variable values, and a reading unit for reading the flash memory, using the estimated read reference voltage.

The variable values include at least one or more of a programming/erase cycle count, retention time, and a location variable within a block.

Furthermore, the flash memory reading apparatus according to an embodiment of the inventive concept further includes an updating unit for updating the learning model of the neural network by reflecting a difference in characteristics between individual chips constituting the flash memory.

The updating unit obtains labeled sample data for the respective individual chip, using a voltage optimization scheme, and updates the learning model of the neural network, using the labeled sample data.

The neural network minimizes a predefined loss function through training using a training data set including the predetermined variable values and read reference voltages for each of the predetermined variable values, and the learning models is generated.

The neural network is optimized through a supervised learning and the learning model is generated.

The location variable within the block includes a location variable of a page within the block, a type variable of the page, and a type variable of a bit line.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 illustrates an exemplary view of a changed threshold voltage distribution that is changed from an ideal threshold voltage distribution when various noises are added, resulting in a high Raw Bit-Error-Rate;

FIG. 2 illustrates an operation flowchart of a method for reading a flash memory according to an embodiment of the inventive concept;

FIG. 3 illustrates an exemplary view modeling the relationship between the optimal read reference voltage and various system variables through a multi-layer neural network circuit;

FIG. 4 illustrates an exemplary diagram for describing a process of estimating an optimal read reference voltage by inputting a system variable value in the method according to an embodiment of the inventive concept;

FIG. 5 illustrates an exemplary diagram for describing a process of updating a learning model of a neural network by reflecting a difference in characteristics of individual chips;

FIG. 6 illustrates an exemplary diagram for describing a flash memory;

FIG. 7 illustrates an exemplary diagram of comparing a method according to an embodiment of the inventive concept with a method of maintaining an initial optimal read reference voltage value with respect to an MSB page;

FIG. 8 illustrates an exemplary diagram of comparing a method according to an embodiment of the inventive concept with a method of maintaining an initial optimal read reference voltage value with respect to an LSB page;

FIG. 9 illustrates an exemplary diagram of comparing a method according to an embodiment of the inventive concept, in which the characteristics of individual chips are reflected, with a method of maintaining an initial optimal read reference voltage value with respect to an MSB page;

FIG. 10 illustrates an exemplary diagram of comparing a method according to an embodiment of the inventive concept, in which the characteristics of individual chips are reflected, with a method of maintaining an initial optimal read reference voltage value with respect to an LSB page; and

FIG. 11 illustrates a configuration for a flash memory reading apparatus according to an embodiment of the inventive concept.

### DETAILED DESCRIPTION

The above and other aspects, features and advantages of the inventive concept will become apparent from the following description of the following embodiments given in conjunction with the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the concept of the inventive concept to those skilled in the art. The inventive concept may be defined by scope of the claims. Meanwhile, the terminology used herein to describe embodiments of the inventive concept is not intended to limit the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other components, steps, operations, and/or elements in addition to the aforementioned components, steps, operations, and/or elements.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings. The same reference numerals are used for the same components in the drawings and redundant explanations for the same components are omitted.

When electric charges are injected into a floating gate, the NAND flash memory records information in the form of the amount of charge stored by using the features of maintaining the amount of charge injected through an insulator (e.g., SiO₂) without being unchanged. At this time, a process of injecting charges into the floating gate is referred to as “programming”; a process of erasing charges from the floating gate is referred to as “erasing”. Cells constituting the floating gate are the basic unit constituting the NAND flash memory. The amount of charge stored for each unit cell may be identified by measuring the threshold voltage value Vₜₕ of the control gate. The NAND flash memory is categorized into single-level cell (SLC), multi-level cell (MLC), and tri-level cell (TLC) depending on the number of levels for quantizing read threshold voltage values

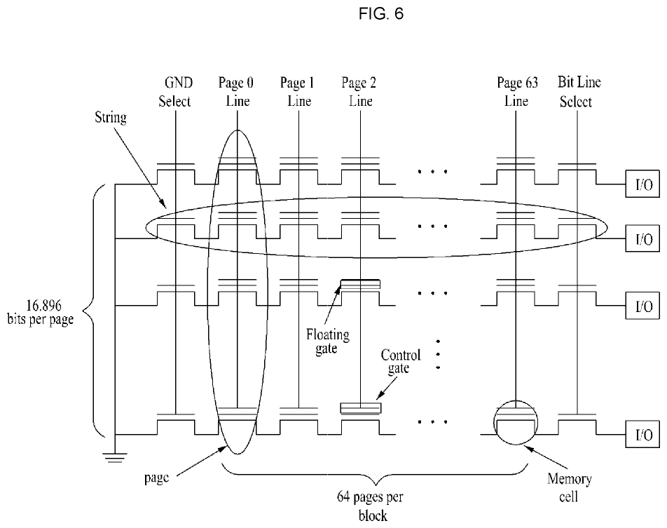

Cells arranged on the same page line form a physical page as shown in FIG. 6. This physical page is further divided into several logical pages depending on the number of bits stored in a single cell. For example, in the case of MLC memory in which a single cell stores information of two bits, the single physical page is divided into two logical pages by being separated into Most Significant Bit (MSB) or Least Significant Bit (LSB) of a cell. This arrangement of physical pages forms a block that is greater than a page. The block is a minimum unit capable of erasing the stored data. The basic unit for programming and reading data is a page that is smaller than a block.

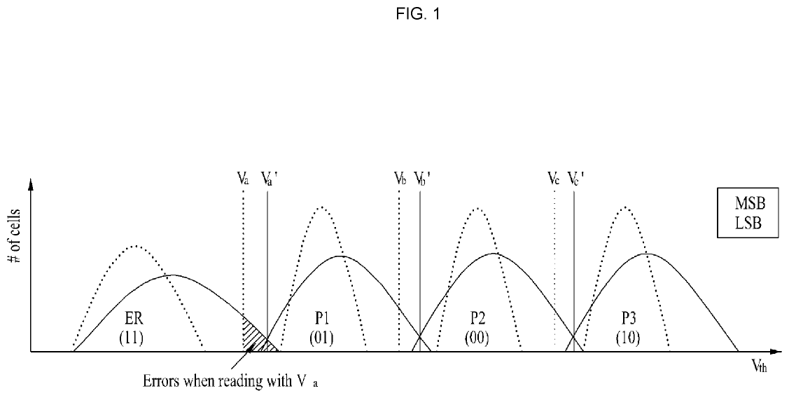

The MLC memory has the distribution of the threshold voltage as shown in FIG. 1. The threshold voltage is determined to be one of the values of 0(00), 1(01), 2(10) and 3(11), using the reference voltages Vₐ, V_{b}, and V_{c}. At this time, the probability that the stored bit value is determined as a bit value different from the stored bit value is referred to as a Raw Bit-Error-Rate. As the amount of charge stored in the floating gate differs from the ideal representative value in the process of physically programming, reading, and erasing data in the flash memory, the Raw Bit-Error-Rate gradually increases. The main factors that cause this reliability degradation include a programming/erasing (PE)-cycle count, retention time, location variables in a block, and the like. Each of the major factors will be described as follows. Herein, FIG. 1 illustrates a changed threshold voltage distribution that is changed from an ideal threshold voltage distribution when a PE-cycle count, retention time, and various noises such as coupling between adjacent cells are added, resulting in a high Raw Bit-Error-Rate.

PE-cycle count N_{PE}: As the programming process of injecting charges into the flash memory cell and the deleting process of removing charges are repeated, abnormal tunneling is caused by a trap inside an insulator. Accordingly, the threshold voltage value is higher than the normal value. The amount of trap inside the insulator increases in proportion to PE-cycle count N_{PE}. Accordingly, the contamination of the floating gate is accumulated as PE-cycle count N_{PE} increases, thereby increasing an error rate.

Retention time ‘t’: A phenomenon that charges of a flash memory cell previously recorded leak with time occurs. The phenomenon causes an error in stored data, which is referred to as a “retention error”. Such the retention error is caused by the structural deformation of the insulator generated by the electric field formed upon reading or programming surrounding pages. The retention error occurs in the direction of decreasing the amount of charge in the cell, and decreases the Raw Bit-Error-Rate in proportion to the retention time T after programming.

Physical location Nₚ, b, and s: The parasitic capacitance between cells increases as more cells are integrated per unit area; when a specific cell is programmed, the amount of charge stored in surrounding cells is affected. This phenomenon is referred to as inter-cell interference. The inter-cell interference is considered as one of the biggest obstacles to design flash memory devices because the inter-cell interference becomes more severe as the process becomes finer. The degree of inter-cell interference varies depending on location variable Nₚ of the page in a block, type variable “s∈{MSB, LSB}”, and bit line type variable “b∈{Even, Odd}”.

According to embodiments of the inventive concept, it is possible to update the learning model of a neural network by modeling the read reference voltage as a multi-layer neural network receiving a system variable, for example, a noise variable, and by continuously updating a weight and the value of bias through regular training or learning upon using a flash memory. In this way, the Raw Bit-Error-Rate of the flash memory is reduced by overcoming the limitations of the conventional method that do not reflect the characteristics of individual chips, thereby extending the life of the flash memory, and significantly reducing the complexity of the channel decoder.

That is, according to an embodiment of the inventive concept, it is possible to reduce the read error rate of NAND flash memory and SSD to extend the life of the flash memory and to reduce the complexity of the channel decoder, thereby increasing the price competitiveness of SSD.

Here, according to an embodiment of the inventive concept, it is possible to estimate the read reference voltage of a flash memory corresponding to variable values, using a neural network of a learning model that is pre-trained for noise variables or system variables (variable values) that include a PE-cycle count, retention time, and location variables (e.g., including the location variable of the page in a block, the type variable of a page, and the type variable of a bit line) within a block. Moreover, according to an embodiment of the inventive concept, it is possible to generate a learning model of a neural network by minimizing the predefined loss function, through training using training data set including predetermined variable values and an optimal value (ground truth) corresponding to read reference voltages for the predetermined variable values, that is, an optimal read reference voltage.

Furthermore, according to an embodiment of the inventive concept, it is possible to update a learning model of a neural network by reflecting differences in characteristics between individual chips constituting a flash memory. In particular, it is possible to obtain labeled sample data for each individual chip by using a voltage optimization scheme, and to update a learning model of a neural network, that is, a weight and a bias value, using the labeled sample data.

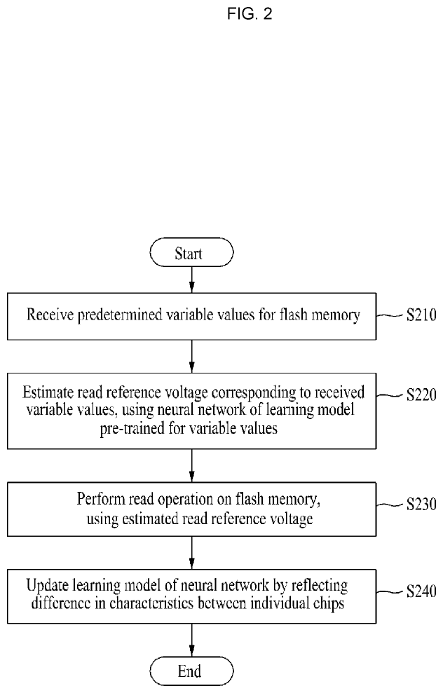

FIG. 2 illustrates an operation flowchart of a method for reading a flash memory according to an embodiment of the inventive concept.

Referring to FIG. 2, the flash memory reading method according to an embodiment of the inventive concept receives predetermined variable values for a flash memory, for example, system variables or noise variables that are capable of affecting the threshold voltage value of the flash memory (S210).

Here, in operation S210, the method may receive variable values including a PE-cycle count, a retention time, and a location variable (e.g., including the location variable of the page in a block, the type variable of a page, and the type variable of a bit line) within the block.

The variable values received in operation S210 may be received from a processor constituting the flash memory reading device. The technical configuration receiving these variable values is obvious to those skilled in the art who are engaged in the industry associated with the technology of the inventive concept.

When the variable values of the flash memory are received through operation S210, the method estimates a read reference voltage corresponding to the received variable values, using the neural network of the learning model learned after being pre-trained through a training data set including variable values (S220).

Here, the neural network is optimized through supervised learning, and thus the learning model may be generated.

That is, in operation S220, the optimal read reference voltage may be estimated by using a neural network circuit (neural network) outputting the optimal read reference voltage, by inputting PE-cycle count N_{PE}, retention time ‘t’, and location variables Nₚ, b, and s within the block, which are variables that affect the state of the threshold voltage distribution.

Herein, in a neural network or neural network circuit, it is possible to generate the optimized learning model that is learned or trained through the data set of noise environment variables and optimal read reference voltages obtained through several experiments in the process stage when SSD is designed, or the data set of input variable values and optimal read reference voltages obtained through experiments, not the process stage. To this end, first of all, the data stored in 100,000 blocks may be divided into training data set βₜᵣ and verification data set βᵥ at a ratio of 3:1; the read reference voltage that is the output of the neural network circuit may be expressed as (Vₐ′, V_{b}′, V_{c}′), assuming the MLC environment. The optimal read reference voltage found through the actual experiment may be expressed as (Vₐ*, V_{b}*, V_{c}*) (ground truth).

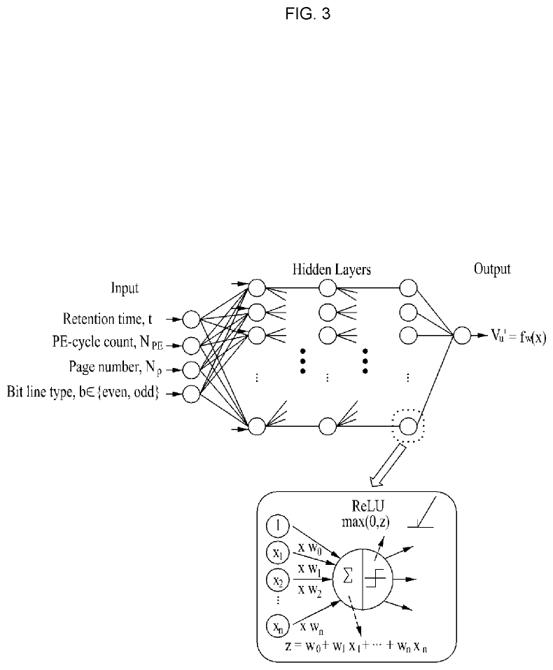

FIG. 3 illustrates modeling the relationship between an optimal read reference voltage and various system variables (N_{PE}, t, Nₚ, b, s) through a multi-layer neural network circuit. As illustrated in FIG. 3, the multi-layer neural network circuit is composed of one input layer, three hidden layers, and one output layer. Each layer is composed of weights and biases, and the weights and values of biases are optimized through supervised learning to have a value from minimizing an error between the function output values (Vₐ′, V_{b}′, Vₛ′) and the actual optimal reference voltage values (Vₐ*, V_{b}*, V_{c}*). The cost function for the supervised learning of the neural network circuit may be expressed as Equation 1 below. The cost function may be expressed as the average value of values from squaring errors between the neural network output value and the optimal read reference voltage.

Cost=∥Vᵤ′−Vᵤ*∥² [Equation 1]

The optimal reference voltage for the supervised learning may be a value from minimizing the Raw Bit-Error-Rate in blocks in the training set, and may be calculated as illustrated in Equation 2 below.

$${V}_{u}^{*} = arg {min}_{k} {P}_{raw} ( {N}_{pg} , t , {N}_{p} , b , s , k ) \qquad [ Equation 2 ]$$

Here, when the combination of system variables is {N_{PE}, t, Nₚ, b, s}, P_{raw}(N_{PE}, t, Nₚ, b, s, k) is the Raw Bit-Error-Rate from setting and measuring the read reference voltage to ‘k’. The training process is performed by using mini-batch training and Adam optimization method. Whenever the respective training is repeated, the training may proceed based on 512 mini-batches, and the learning rate may be set to 0.001.

As such, in the method according to an embodiment of the inventive concept, when the read reference voltage of the flash memory is estimated in operation S220, the data stored in the flash memory is read by using the estimated read reference voltage (S230).

After a read operation is performed on the data stored in the flash memory, the learning model of the neural network is updated by performing online learning through a fine-tuning scheme based on the small number of pieces of data intermittently generated by individual chips in an actual operating environment (S240).

Here, in operation S240, the learning model may be updated by updating the weights and bias values of the neural network, and it is possible to overcome the limitation of the difference in read reference voltages capable of occurring depending on the difference in characteristics of individual chips, using the neural network of the updated learning model, thereby extending the life of the memory through reducing the Raw Bit-Error-Rate of flash memory, and effectively reducing the burden of the channel decoder.

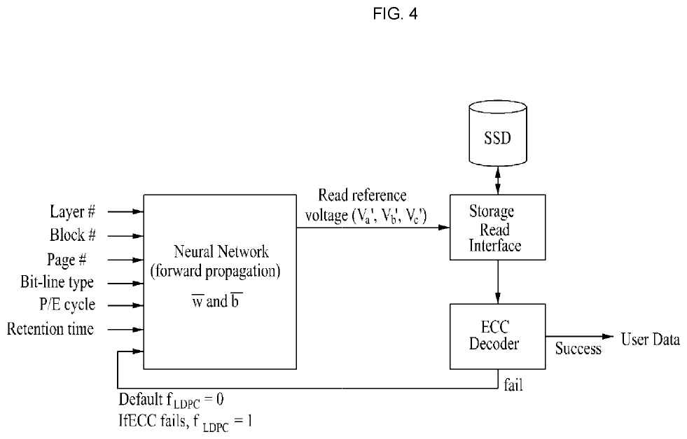

The method according to an embodiment of the inventive concept will be described in detail with reference to FIGS. 4 to 10 as follows.

FIG. 4 illustrates an exemplary diagram for describing a process of estimating an optimal read reference voltage by inputting a system variable value in the method according to an embodiment of the inventive concept. FIG. 4 illustrates the concept that a controller reads data from a flash memory and enters the data as an input to ECC by using the estimated value of the optimal read reference voltage output by inputting a system variable, which is information about a device, when a NAND flash-based storage medium is used.

As illustrated in FIG. 4, a neural network is modeled such that the structure between the optimal read reference voltage and system variables, which is suggested in the conventional technology, may be expressed as a nonlinear function; the bias is gradually added to the weighted sum of the input variable by using the learning model of the neural network to express a nonlinear function; accordingly, it is possible to estimate the read reference voltage (Vₐ′, V_{b}′, V_{c}′) corresponding to the input variable values, to read the data stored in SSD by using the estimated read reference voltage, and thus the user data is read by using an ECC decoder. In other words, the neural network outputs the optimal read reference voltage and inputs the factors that cause the change in the threshold voltage, and changes the corresponding problem into a neural network circuit from adding several hidden layers. In such the neural network model, a nonlinear function may be expressed by stepwise adding a bias to the weighted sum of the input variable.

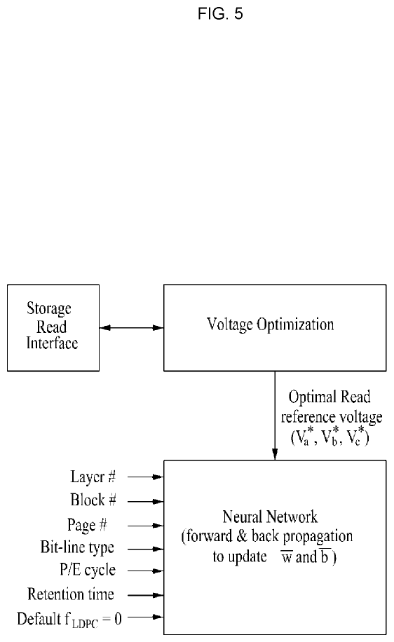

Technologies for the read reference voltage for minimizing the Raw Bit-Error-Rate depending on the state of the threshold voltage distribution of the NAND flash memory have already been commercialized. For example, there is a sampling scheme that changes the read reference voltage, measures the Raw Bit-Error-Rate from the difference between the decoded output value of Error Correcting Codes (ECC) and the read data, and exhaustively detects a threshold voltage that minimizes the measured Raw Bit-Error-Rate. Moreover, there is a difference-based approximation scheme that adopts an optimal read reference voltage, assuming that each level value of user data has a similar probability distribution, using technology capable of being applied even in case of ECC decoding failure. These technologies are referred to as “voltage optimization”. The voltage optimization step is performed when ECC decoding fails, or intermittently. The weights and biases of the neural network circuit may be updated through online supervised learning to reflect the difference in characteristics of each flash memory chip generated in the process procedure, using the optimal read reference voltage obtained by being performed irregularly as new learning data of the neural network circuit. The online supervised learning process may be performed by setting the pre-trained neural network model as an initial model for average performance in the process procedure and by using a fine-tuning scheme based on the initial model. In this way, the learning model of the neural network may be updated by quickly reflecting the characteristics of individual chips with the small number of pieces of data. That is, as illustrated in FIG. 5 illustrating an embodiment of bringing the result of performing the read reference voltage optimization scheme performed irregularly and executing the online learning of the neural network circuit to update weights and values of biases of the neural network circuit such that the individual user environment and each SSD are matched with the neural network circuit determined at the manufacturing stage, the weights and bias values of the neural network circuit may be adaptively updated by using the voltage optimization scheme depending on the characteristics of individual chips and the user environment. Accordingly, the method according to an embodiment of the inventive concept may overcome the limitations of the conventional method by continuously updating the weights and values of biases through periodic learning when a flash memory is used. In particular, a method according to an embodiment of the inventive concept may update a learning model of a neural network by reflecting differences in characteristics between individual chips constituting a flash memory, and may obtain labeled sample data for each individual chip by using a voltage optimization scheme and may update a learning model of a neural network, using the labeled sample data.

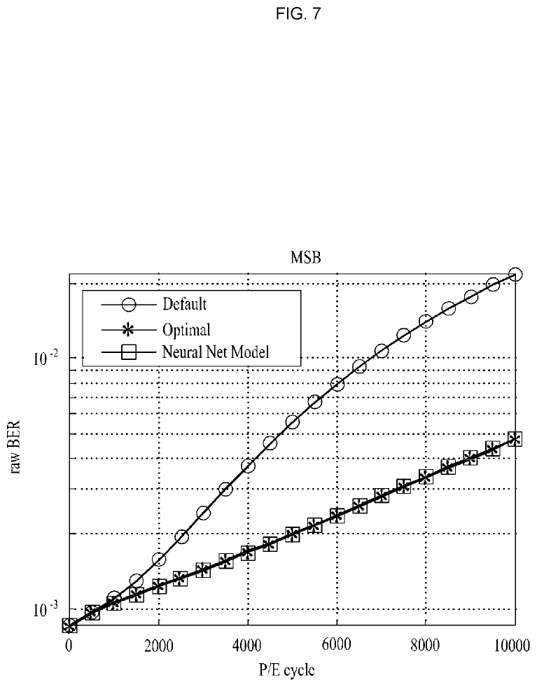

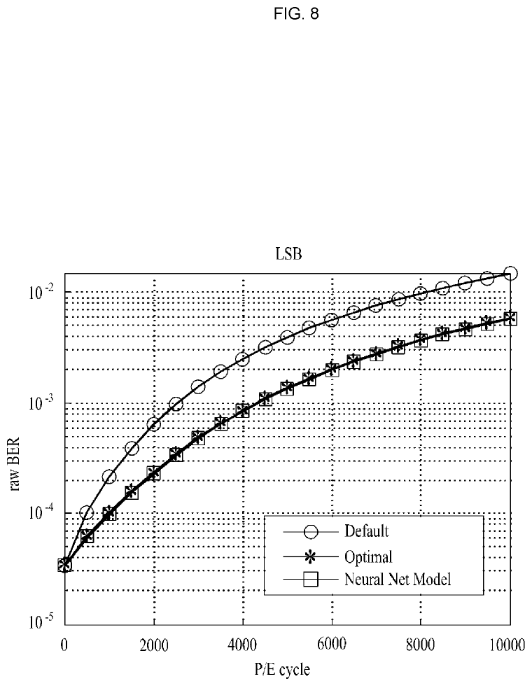

FIG. 7 illustrates an exemplary diagram of comparing a method according to an embodiment of the inventive concept with a method of maintaining an initial optimal read reference voltage value with respect to an MSB page. In FIG. 7, the performance of the method of selecting the optimal read reference voltage value is compared with the performance of the method of maintaining the initial optimal read reference voltage value, with respect to the MSB page for each variable. FIG. 8 illustrates an exemplary diagram of comparing a method according to an embodiment of the inventive concept with a method of maintaining an initial optimal read reference voltage value with respect to an LSB page. In FIG. 8, the performance of the method of selecting the optimal read reference voltage value is compared with the performance of the method of maintaining the initial optimal read reference voltage value, with respect to the LSB page for each variable.

As understood through FIGS. 7 and 8, as a method of selecting the optimal read reference voltage is compared with a method of maintaining the initial optimal read reference voltage depending on the number of reading/writing cycles, with respect to the performance of the proposed neural network-based algorithm for each of MSB page and LSB page, and all error variables, it may be seen that the proposed method in all environments has the same performance as the selection of the optimal read reference voltage, through each graph.

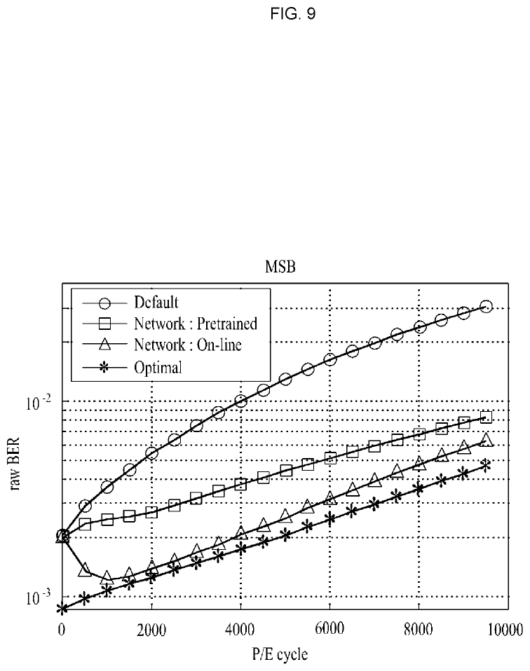

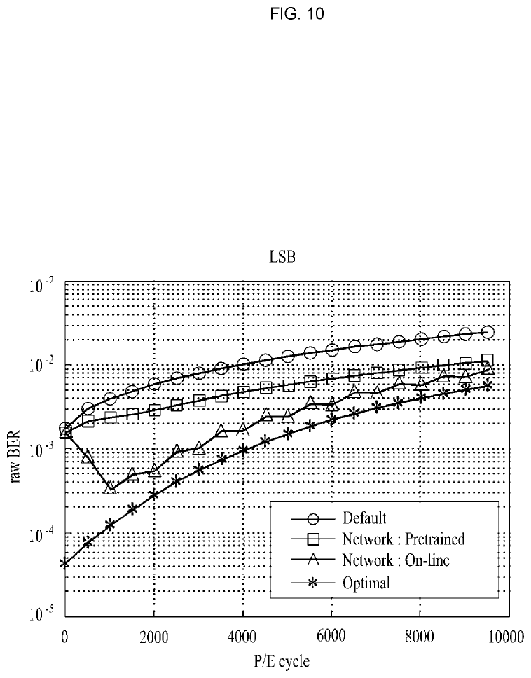

FIG. 9 illustrates an exemplary diagram of comparing a method according to an embodiment of the inventive concept, in which the characteristics of individual chips are reflected, with a method of maintaining an initial optimal read reference voltage value with respect to an MSB page. In FIG. 9, in an environment where there is a difference in characteristics of individual chips, the performance of the method of selecting the optimal read reference voltage value is compared with the performance of the method of maintaining the initial optimal read reference voltage value, with respect to the MSB page for each variable. FIG. 10 illustrates an exemplary diagram of comparing a method according to an embodiment of the inventive concept, in which the characteristics of individual chips are reflected, with a method of maintaining an initial optimal read reference voltage value with respect to an LSB page. In FIG. 9, in an environment where there is a difference in characteristics of individual chips, the performance of the method of selecting the optimal read reference voltage value is compared with the performance of the method of maintaining the initial optimal read reference voltage value, with respect to the LSB page for each variable.

As understood through FIGS. 9 and 10, as the performance of intermittent online learning from reflecting the difference in characteristics occurring in the process procedure is indicated, it may be seen that the intermittent online learning has the performance close to the selection of the optimal read reference voltage by reflecting the characteristics of individual chips as the proposed algorithm is being learned. It may be seen that this indicates the performance gain of the order of magnitude as compared to the use of a single read reference voltage.

As such, a method according to embodiments of the inventive concept may output the optimal read reference voltage in the current noise environment and may update the learning model of a neural network by modeling the read reference voltage as a multi-layer neural network receiving variables indicative of a system variable, for example, a noise variable, and by continuously updating a weight and the value of bias through regular training or learning upon using a flash memory. In this way, the Raw Bit-Error-Rate of the flash memory is reduced by overcoming the limitations of the conventional method that do not reflect the characteristics of individual chips, thereby extending the life of the flash memory, and significantly reducing the complexity of the channel decoder.

Furthermore, a method according to embodiments of the inventive concept may reduce the read error rate of NAND flash memory and SSD to extend the life of the flash memory and to reduce the complexity of the channel decoder, thereby increasing the price competitiveness of SSD.

Moreover, the method according to an embodiment of the inventive concept may achieve a maximum of 6 times lower Raw Bit-Error-Rate as comparing the reference voltage estimated by the learning process with the basic read reference voltage, as the number of P/E increases. It may be seen that this achieves a Raw Bit-Error-Rate similar to the optimal read reference voltage obtained for each block.

Also, the method according to an embodiment of the inventive concept may reflect differences in characteristics of individual flash memory chips by regularly updating the neural network circuit through supervised learning based on data of individual chips, and may adaptively change the nonlinear read reference voltage selection function depending on a user's environment.

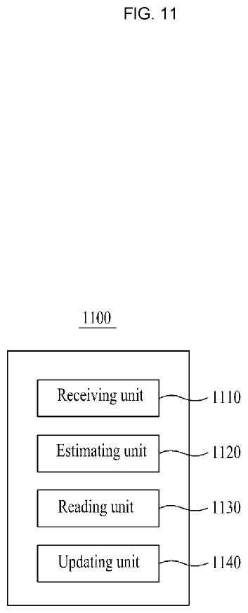

FIG. 11 shows a configuration for a flash memory reading apparatus according to an embodiment of the inventive concept, and illustrates a conceptual configuration of an apparatus for performing the methods of FIGS. 1 to 10.

Referring to FIG. 11, an apparatus 1100 according to an embodiment of the inventive concept includes a receiving unit 1110, an estimating unit 1120, a reading unit 1130, and an updating unit 1140.

The receiving unit 1110 receives predetermined variable values for a flash memory, for example, system variables or noise variables that are capable of affecting the threshold voltage value of the flash memory.

Here, the receiving unit 1110 may receive variable values including a PE-cycle count, a retention time, and a location variable (e.g., including the location variable of the page in a block, the type variable of a page, and the type variable of a bit line) within the block.

The estimating unit 1120 estimates a read reference voltage corresponding to the received variable values, using the neural network of the learning model learned after being pre-trained through a training data set including variable values.

At this time, the neural network may minimize a predefined loss function through training using a training data set including predetermined variable values, that is, respective values of noise environment variables, and optimal read reference voltages for each of the predetermined variable values, and thus the learning models may be generated.

Here, the neural network is optimized through supervised learning, and thus the learning model may be generated.

That is, the estimating unit 1120 may estimate the optimal read reference voltage, using a neural network circuit outputting the optimal read reference voltage, by inputting PE-cycle count N_{PE}, retention time ‘t’, and location variables Nₚ, b, and s within the block, which are variables that affect the state of the threshold voltage distribution.

The reading unit 1130 reads data stored in the flash memory, using the estimated read reference voltage.

The updating unit 1140 updates a learning model of the neural network by reflecting differences in characteristics between individual chips constituting the flash memory.

Here, the updating unit 1140 updates the learning model of the neural network by performing online learning through a fine-tuning scheme based on the small number of pieces of data intermittently generated by individual chips in an actual operating environment.

At this time, the updating unit 1140 may update the learning model by updating the weights and bias values of the neural network, and may overcome the limitation of the difference in read reference voltages capable of occurring depending on the difference in characteristics of individual chips, using the neural network of the updated learning model, thereby extending the life of the memory through reducing the Raw Bit-Error-Rate of flash memory, and effectively reducing the burden of the channel decoder. That is, the updating unit 1140 may obtain the labeled sample data for each individual chip, using a voltage optimization scheme, and may update the learning model of a neural network, using the labeled sample data.

Even though the description in the apparatus in FIG. 11 is omitted, it will be apparent to those skilled in the art that the configuration means constituting FIG. 11 may include all content described in FIGS. 1 to 10.

While embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

According to embodiments of the inventive concept, it is possible to update the learning model of a neural network by modeling the read reference voltage as a multi-layer neural network receiving a system variable, for example, a noise variable, and by continuously updating a weight and the value of bias through regular training or learning upon using a flash memory. In this way, the Raw Bit-Error-Rate of the flash memory is reduced by overcoming the limitations of the conventional method that do not reflect the characteristics of individual chips, thereby extending the life of the flash memory, and significantly reducing the complexity of the channel decoder.

According to embodiments of the inventive concept, it is possible to reduce the read error rate of NAND flash memory and SSD to extend the life of the flash memory and to reduce the complexity of the channel decoder, thereby increasing the price competitiveness of SSD.

According to embodiments of the inventive concept, the Raw Bit-Error-Rate may be reduced by adjusting the read reference voltage of a semiconductor storage device, which is essentially used for big data, deep learning, and IoT, which are major technologies of the 4th industrial revolution.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A flash memory reading method, the method comprising:
receiving predetermined variable values with respect to a flash memory;
estimating a read reference voltage corresponding to the received variable values, using a neural network of a pre-trained learning model with respect to the variable values; and
reading the flash memory, using the estimated read reference voltage.

2. The method of claim 1, wherein the variable values include at least one or more of a programming/erase cycle count, retention time, and a location variable within a block.

3. The method of claim 1, further comprising:
updating the learning model of the neural network by reflecting a difference in characteristics between individual chips constituting the flash memory.

4. The method of claim 3, wherein the updating of the learning model includes:
obtaining labeled sample data for the respective individual chip, using a voltage optimization scheme; and
updating the learning model of the neural network, using the labeled sample data.

5. The method of claim 1, wherein the neural network minimizes a predefined loss function through training using a training data set including the predetermined variable values and read reference voltages for each of the predetermined variable values, and the learning models is generated.

6. The method of claim 5, wherein the neural network is optimized through a supervised learning and the learning model is generated.

7. The method of claim 2, wherein the location variable within the block includes a location variable of a page within the block, a type variable of the page, and a type variable of a bit line.

8. A memory reading method, the method comprising:
receiving predetermined variable values with respect to a memory;
estimating a read reference voltage corresponding to the received variable values, using a neural network of a pre-trained learning model with respect to the variable values; and
reading the memory, using the estimated read reference voltage.

9. The method of claim 8, wherein the variable values include at least one or more of a programming/erase cycle count, retention time, and a location variable within a block, when the memory is a flash memory.

10. The method of claim 8, further comprising:
updating the learning model of the neural network by reflecting differences in characteristics between individual chips constituting the memory.

11. The method of claim 10, wherein the updating of the learning model includes:
obtaining labeled sample data for the respective individual chip, using a voltage optimization scheme; and
updating the learning model of the neural network, using the labeled sample data.

12. A flash memory reading apparatus, the apparatus comprising:
a receiving unit configured to receive predetermined variable values with respect to a flash memory;
an estimating unit configured to estimate a read reference voltage corresponding to the received variable values, using a neural network of a pre-trained learning model with respect to the variable values; and
a reading unit configured to read the flash memory, using the estimated read reference voltage.

13. The apparatus of claim 12, wherein the variable values include at least one or more of a programming/erase cycle count, retention time, and a location variable within a block.

14. The apparatus of claim 12, further comprising:
an updating unit configured to update the learning model of the neural network by reflecting a difference in characteristics between individual chips constituting the flash memory.

15. The apparatus of claim 14, wherein the updating unit obtains labeled sample data for the respective individual chip, using a voltage optimization scheme, and updates the learning model of the neural network, using the labeled sample data.

16. The apparatus of claim 12, wherein the neural network minimizes a predefined loss function through training using a training data set including the predetermined variable values and read reference voltages for each of the predetermined variable values, and the learning models is generated.

17. The apparatus of claim 16, wherein the neural network is optimized through a supervised learning and the learning model is generated.

18. The apparatus of claim 13, wherein the location variable within the block includes a location variable of a page within the block, a type variable of the page, and a type variable of a bit line.
